(19) United States
(12) Patent Application Publication
(10) Pub. No.: US 2007/0007071 A1
(43) Pub. Date: Jan. 11, 2007

(54) Power steering system for ATV

(76) Inventor: Plourde Aime, Montreal (CA)

Correspondence Address: INVENTARIUM, Suite 1607, 4050 Rosemont Blvd., Montreal, QC, H1X 1M4, CA

(21) Appl. No.: 11/482,585

(22) Filed: Jul. 6, 2006

Related U.S. Application Data
(60) Provisional application No. 60/697,030, filed on Jul. 6, 2005.

(51) Int. Cl. B62D 5/04

(52) U.S. Cl. 180/444

(57) ABSTRACT

A power steering systems complements a standard rack and pinion system and which comprises an actuator, a motor assembly, and cables. The rack and pinion steering system is pivotally connected to rods. The rods are being themselves pivotally connected to a track connecting assembly and that track connecting assembly acts as an interface connecting the tracks and the rack and pinion steering system. A torque applied to a steering column rotates a connecting stem which is rotationally attached to an extensible rod. The extensible rod is part of a piston which consists of a body and the extensible rod. Two springs and two plates are located within the body as well as part of the extensible rod which extends into the body. The plates are fixedly fixedly attached to the extensible rod. A motor, part of a motor assembly, effects pulling of the cables by way of its rotation.

This application claims priority based on provisional application 60/697,030 filed Jul. 6, 2005

### BACKGROUND OF THE INVENTION

1. Field of the Invention

The invention relates generally to steering system but more particularly to a power steering system adapted to the need of vehicles such as snowmobiles and various types of all terrain vehicles.

2. Background of the Invention

All terrain vehicles have fairly basic steering systems and for the most part, that system is functional. However, when using a snowmobile wherein skis replace wheels or again in using a new breed of mofified ATV wherein two or four wheels are replaced by tracks, steering becomes much more difficult and requires great strength on the part of the driver.

Because the type of vehicles concerned are often used in cold climates, hydraulically assisted steering systems are not ideal since the oil can become thick and the advantage of hydraulics becomes moot.

### SUMMARY OF THE INVENTION

It is a main advantage of this invention to reduce the strength needed for steering.

It is another advantage of this invention to require very little electrical power to operate on.

It is yet another advantage of this invention to provide for a steering system that is not affected by temperature.

In order to do so, the invention comprises a power steering system that complements a standard rack and pinion system and which comprises an actuator, a motor assembly, and cables. The cables joining said motor assembly to the rack and pinion steering system. The rack and pinion steering system is pivotally connected to rods. The rods are being themselves pivotally connected to a track connecting assembly and that track connecting assembly acts as an interface connecting the tracks and the rack and pinion steering system.

A torque applied to a steering column rotates a connecting stem which is rotationally attached to an extensible rod. The extensible rod is part of a piston which consists of a body and the extensible rod. Two springs and two plates are located within the body as well as part of the extensible rod which extends into the body. The plates are fixedly fixedly attached to the extensible rod.

A motor, part of a motor assembly, effects pulling of the cables by way of its rotation. The motor assembly is fixedly attached on a frame located at a suitable place on a vehicle and further comprises an electro magnetically actuated clutch means to actuate the cables. The rack connecting assembly is comprised of a curved element, a plate, and a plate holder.

In one embodiment, the clutch means comprises a shaft connected disc which is directly connected to a shaft of the motor. An electro magnet, located within a free disc, pulls a magnetically actuated disc towards the free disc, taking with it a plurality of pins which are fixedly attached to the magnetically actuated disc. Each one of the plurality of pins entering one of a plurality of holes made into the free disc so as to lock the free disc into rotation along with the shaft connected disc.

When the electro magnet is deactivated, biasing means pull the magnetically actuated disc towards the shaft connected disc so that the free disc is once again free.

Locking the free disc into rotation induces rotation of the free disc which induces pulling of said cables located peripherically off the free disc in a cable slit.

Generally, the power steering system has the following method of operation:

At rest, the piston has both springs un biased by the plates, when a turn on the steering column has the connecting stem pull on the extensible rod, one of the springs is compressed by one of the plates and the contact actuates one of the switches. A turn on the steering column in an opposite direction has the connecting stem push on the extensible rod and the other spring is compressed by the other plate and the contact actuates the other switch.

In a variation of the embodiment, the clutch means has a shaft connected disc which is directly connected to the shaft of the motor. The electro magnet located within the free disc pulls a magnetically actuated disc towards the free disc. A series of slip discs regulate rotation of the free disc so as to pull on the cables. A retainer plate extending from the shaft and a slip disc cover, both cooperating to retain the slip discs. Sslip disc mechanical fasteners to hold the slip disc cover and a retainer plate mechanical fastener to hold the retainer plate. The electro magnet moving so as to press the retainer plate against the slip discs so as to increase friction between the slip discs so that the free disc rotates and pulls on the cables.

In yet another variation of the embodiment, the clutch means consists of brake pads selectively engaging or disengaging a brake cylinder The motor induces rotation of the brake cylinder when the brake pads engage the brake cylinder. The brake cylinder rotate so that the cables guided by the cable slit are pulled so as to provide steering. Brake pad components comprising the brake pads are actuated by the electro magnet moving an actuator and a clutch plate. This variation operates so that the electro magnet moves said actuatior away from the brake pads so that the actuator no longer rotates along with the brake pads. The actuator then moves in one of two possible direction in relation with the brake pads which both results in the actuator applying biasing pressure against either one of the brake pads and the brake pads causing the brake cylinder to rotate so that the cables guided by the cable slit are pulled so as to provide steering.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

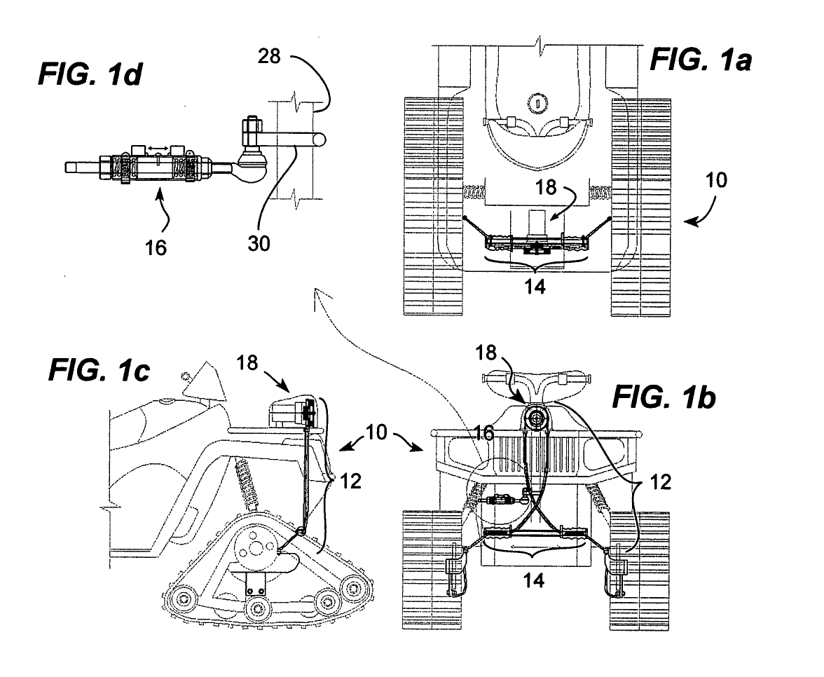

FIG. 1a Top view of an ATV with a see through view indicating the location of the power steering system.

FIG. 1b Side view of FIG. 1a showing the motor assembly on the hood.

FIG. 1c Front view of FIG. 1a showing the actuator.

FIG. 1d closer front view of the actuator of FIG. 1c.

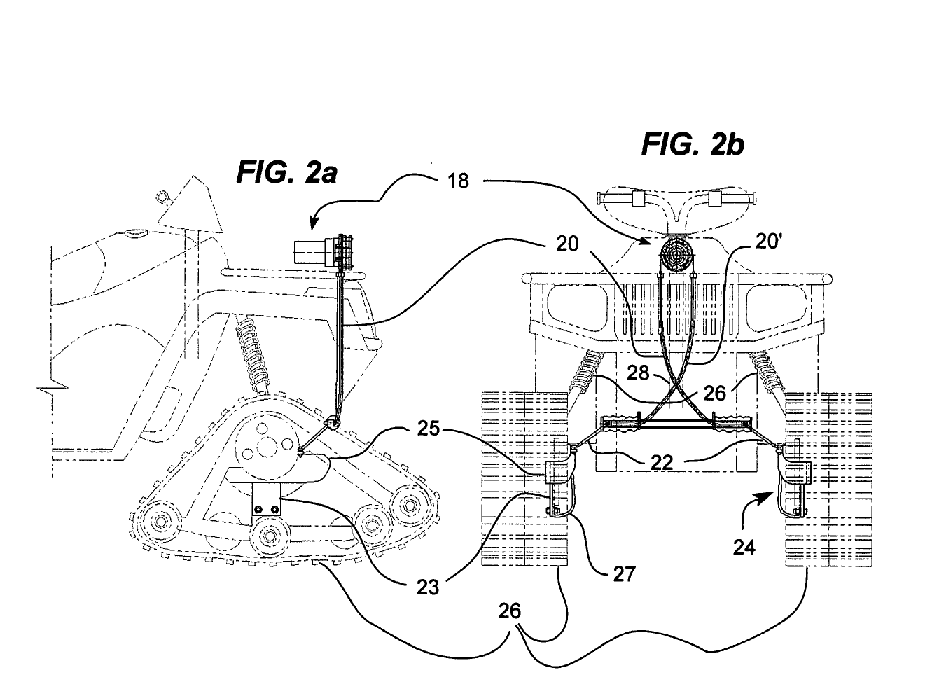

FIG. 2a Side view as in FIG. 1b.

FIG. 2b Front view as in FIG. 1c.

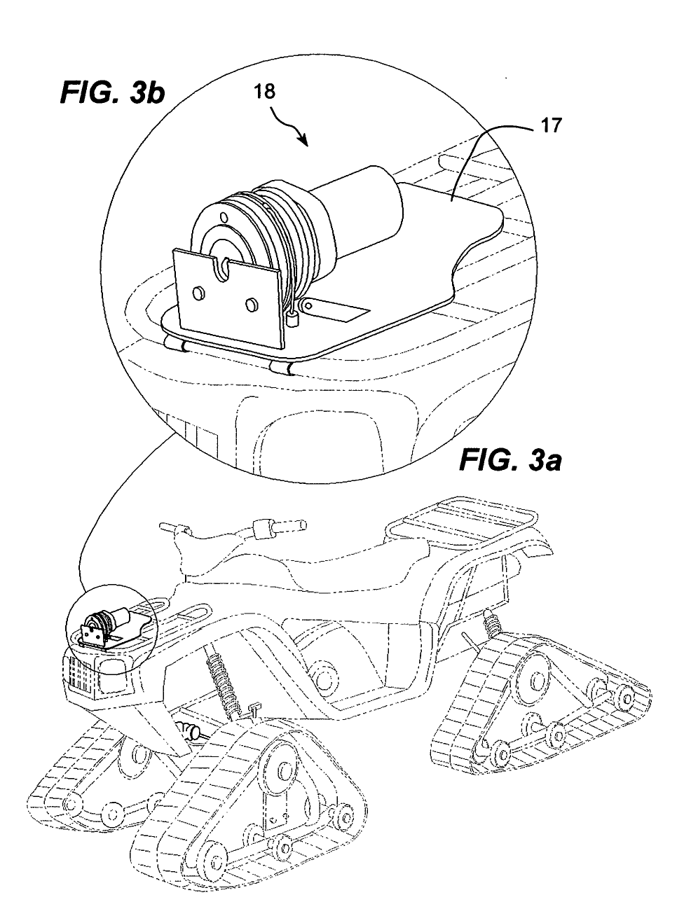

FIG. 3a Perspective view of the ATV with the motor assembly on the hood.

FIG. 3b Perspective view detail of the motor assembly of FIG. 3a.

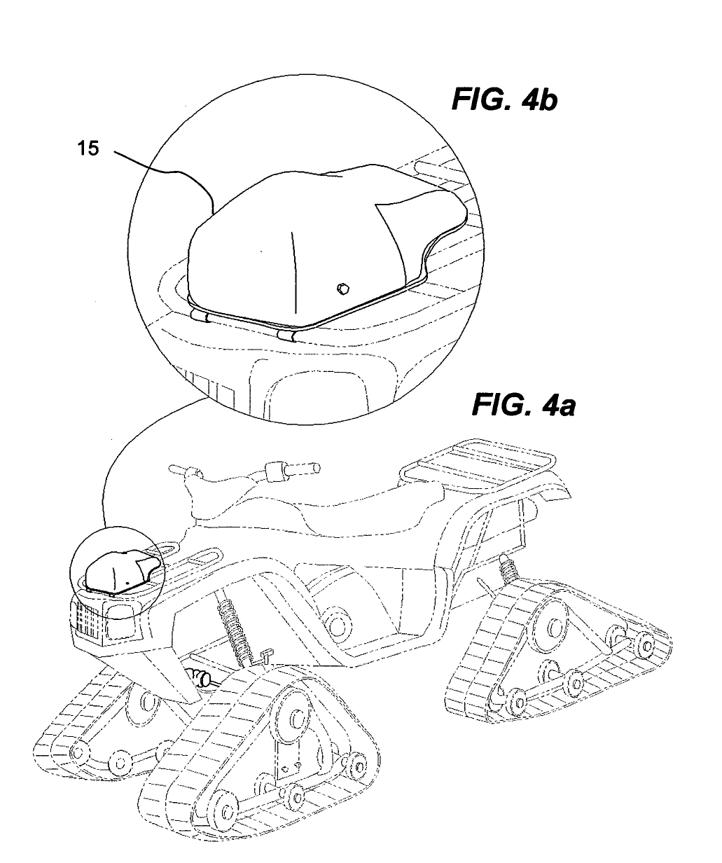

FIG. 4a Perspective view of the ATV.

FIG. 4b Perspective view detail as in FIG. 3b with the motor assembly covered.

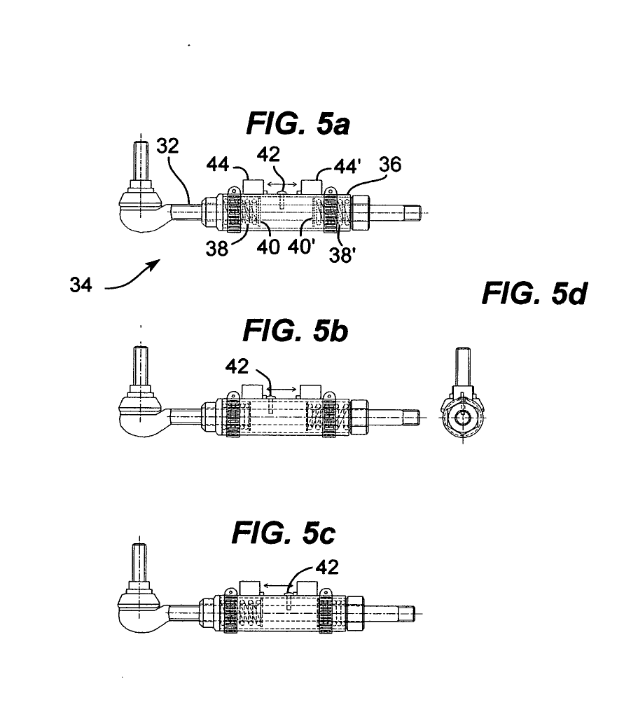

FIG. 5abc Three side views of the actuator with the contact in the center, left, right position and end view respectively.

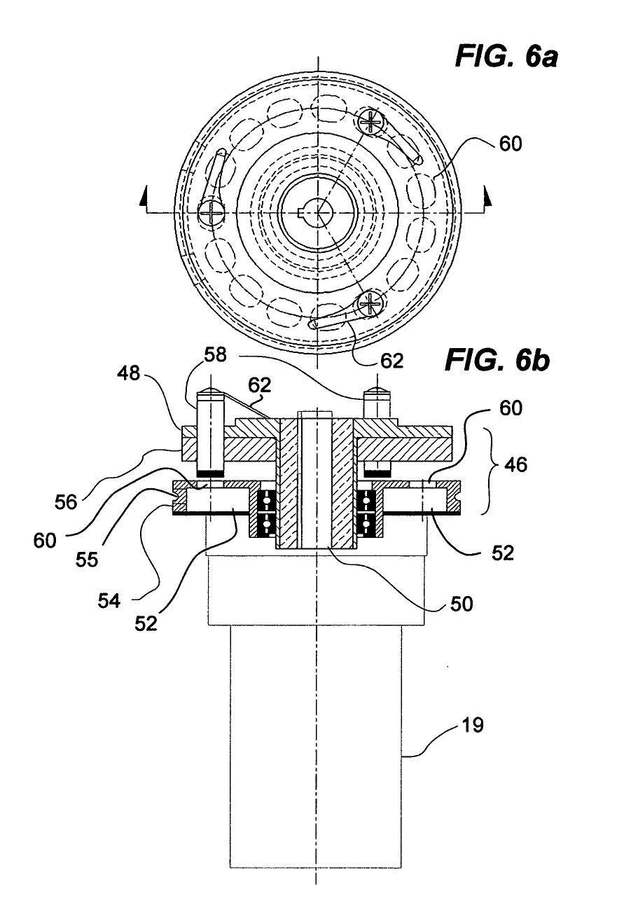

FIG. 6a Top view of the motor assembly showing the shaft connecting disc.

FIG. 6b Side cutaway view of the motor assembly with the magnetically attracted disc biased towards the shaft connected disc.

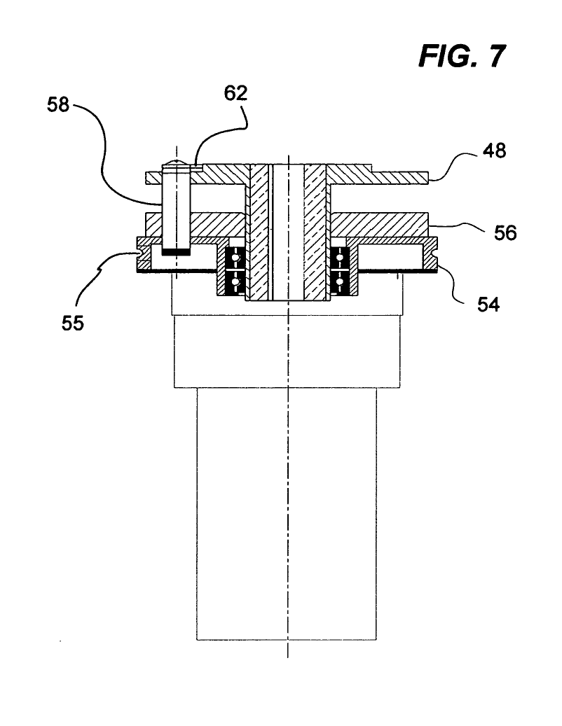

FIG. 7 Side cutaway view of the motor assembly with the magnetically attracted disc biased away from the shaft connected disc.

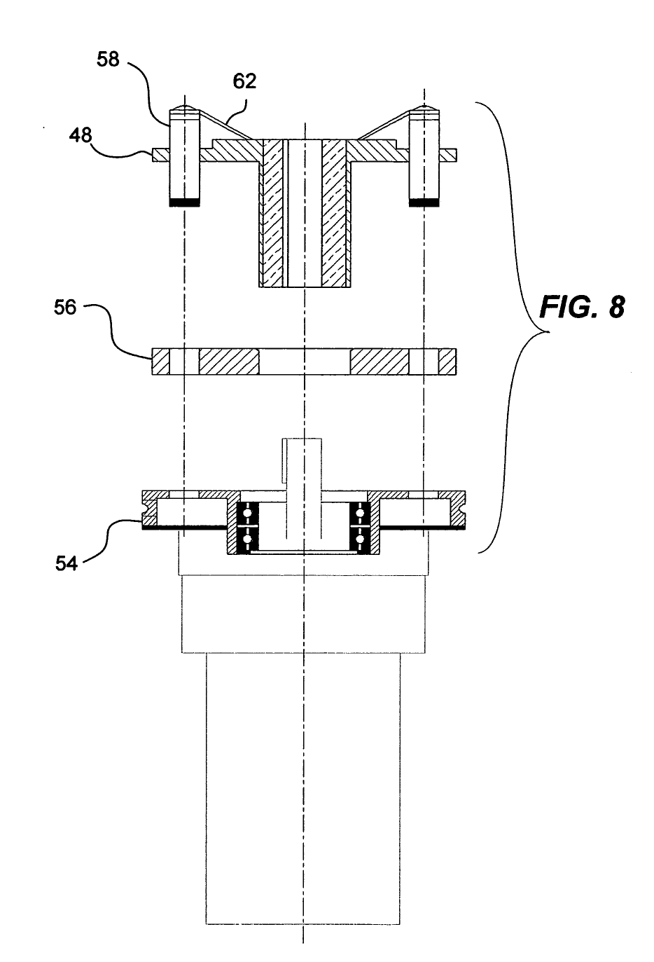

FIG. 8 Exploded cutaway view of the motor assembly.

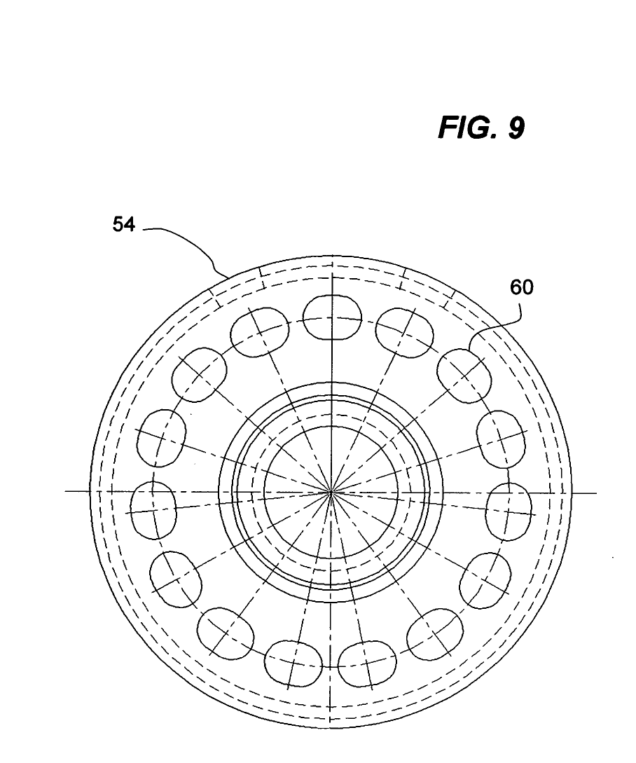

FIG. 9 Top view of the free disc.

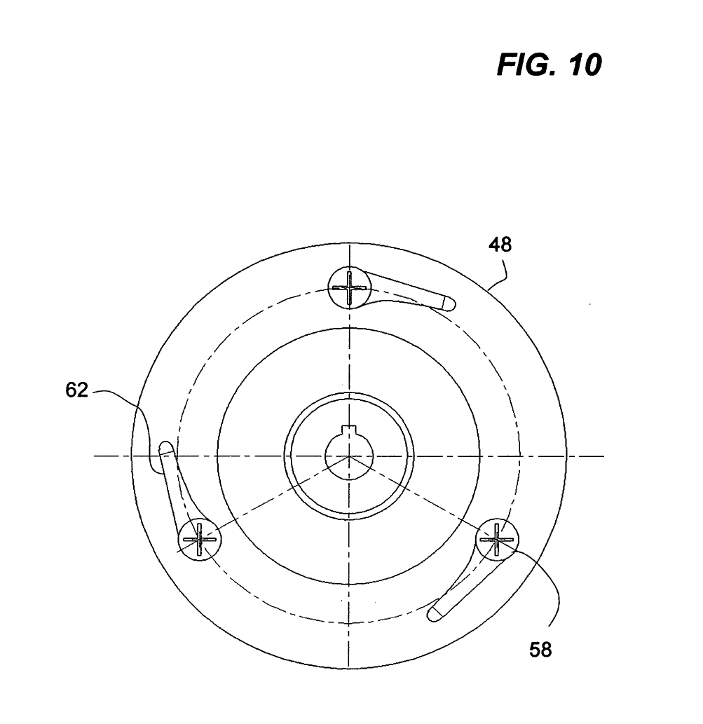

FIG. 10 Top view of the shaft connected disc with biasing means and pins.

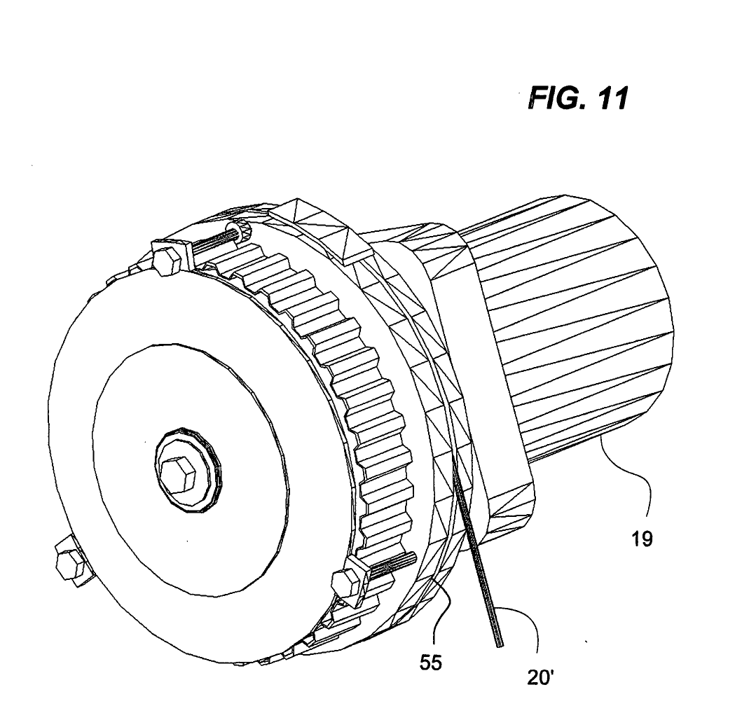

FIG. 11 Perspective view of the motor assembly.

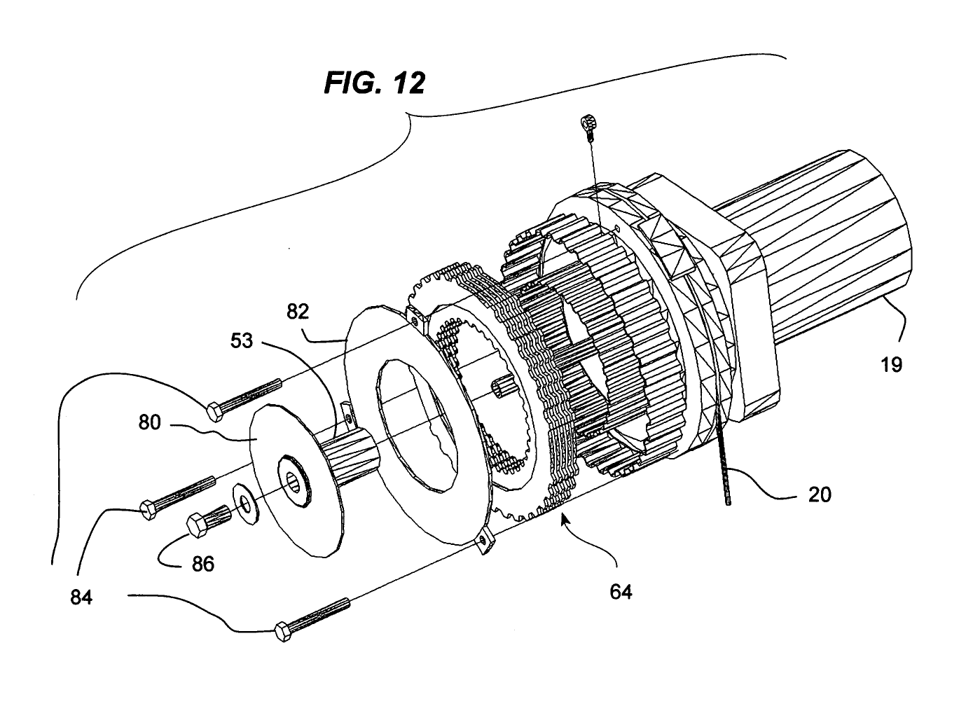

FIG. 12 Perspective exploded view of the motor assembly with the slip discs partially dispersed.

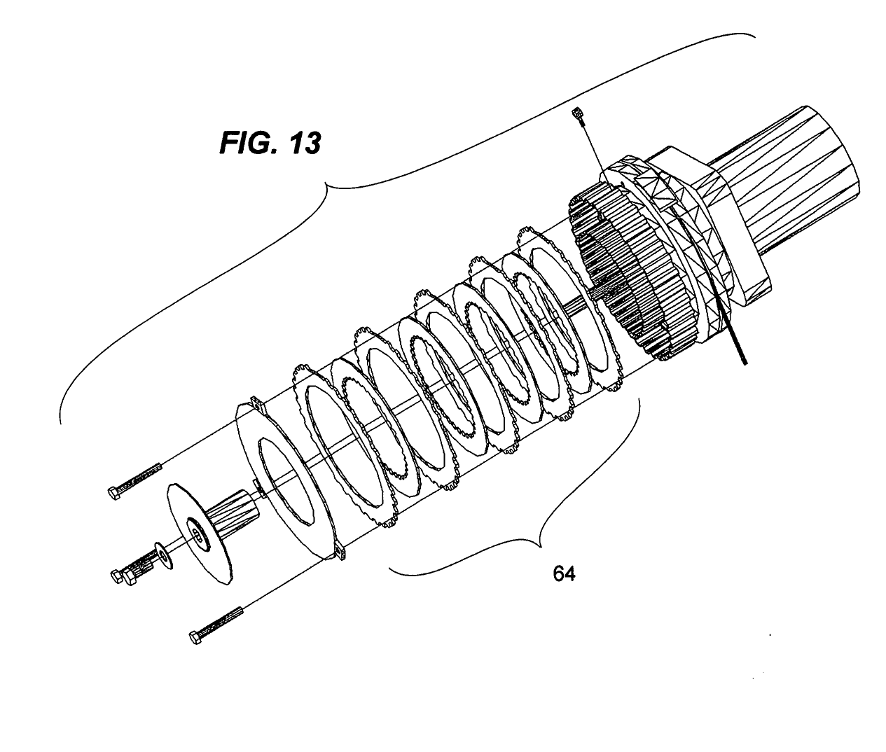

FIG. 13 Perspective exploded view of the motor assembly with the slip discs dispersed.

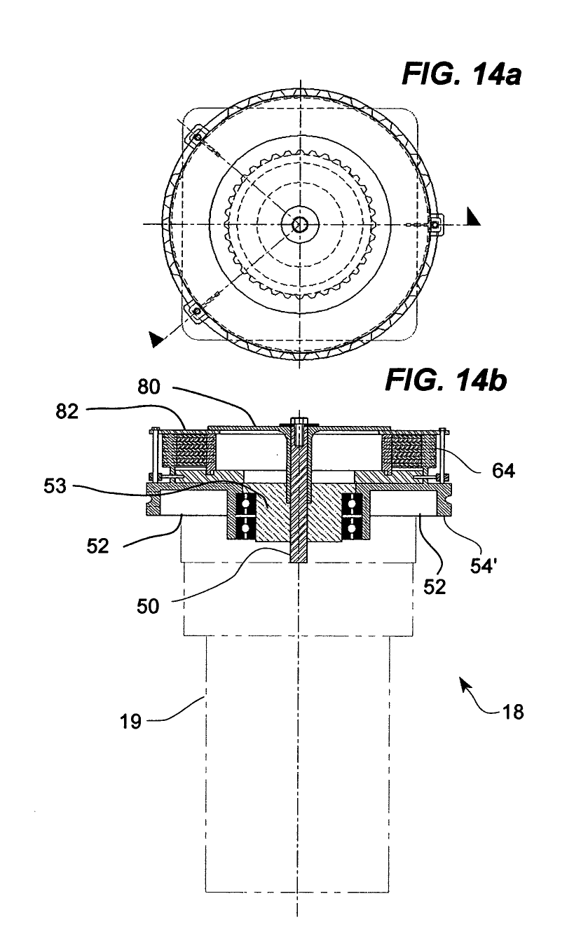

FIG. 14ab Top and side views respectively of the motor assembly with the slip discs.

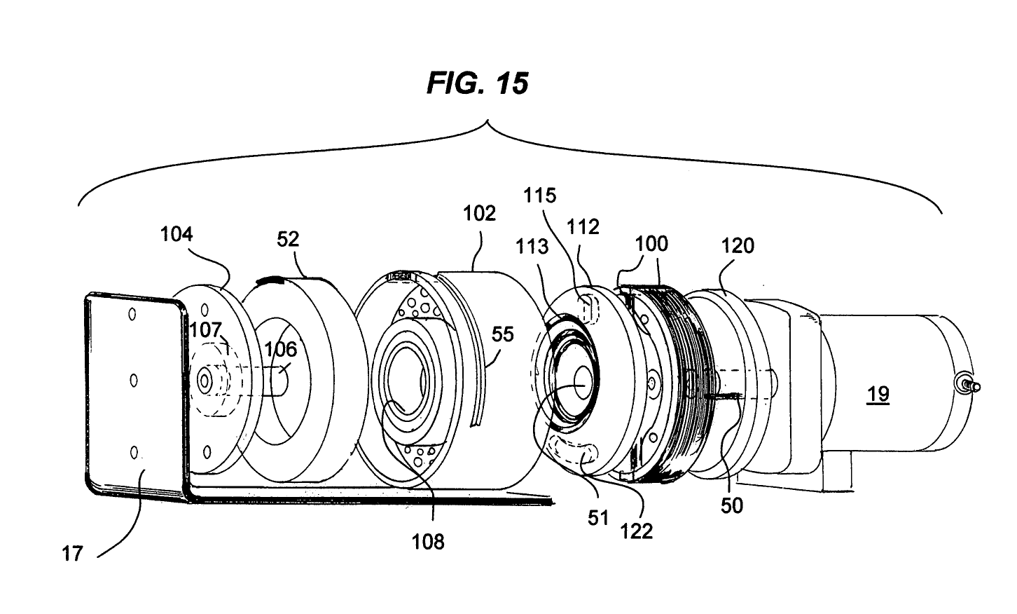

FIG. 15 Perspective exploded view of the motor assembly with the disc pads.

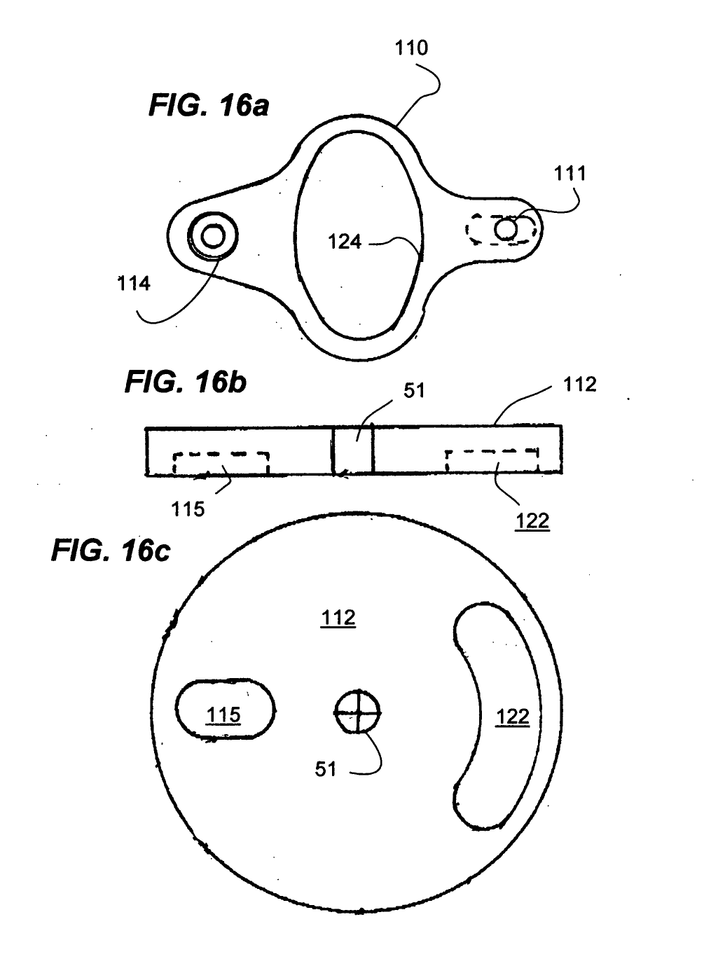

FIGS. 16a-c Front view of the actuator, side view of the clutch plate, and front view of the clutch plate, respectively.

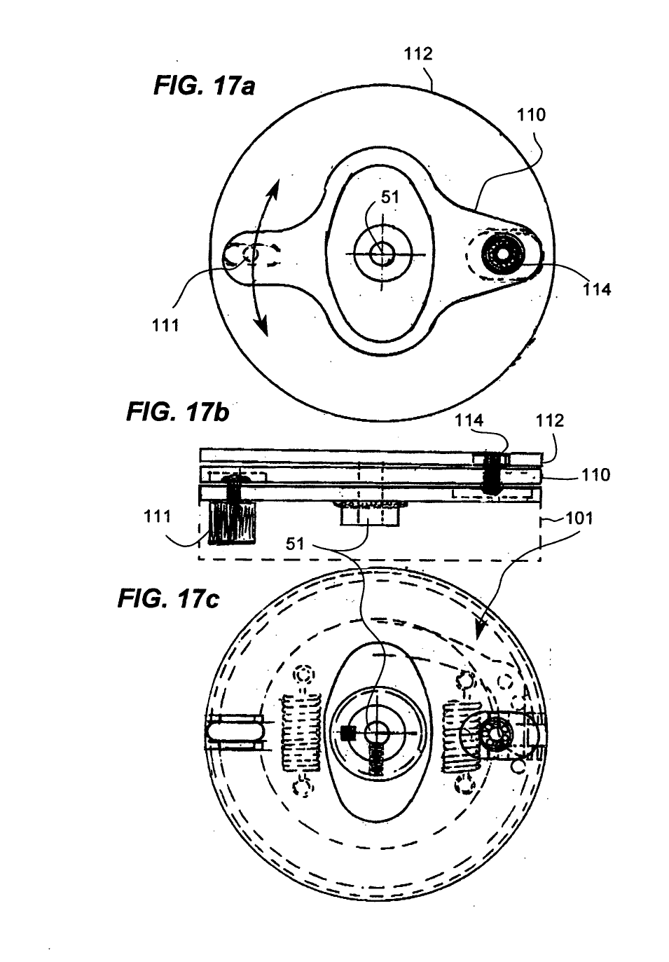

FIGS. 17a-c Front view of the actuator and clutch plate, side view of the clutch plate, actuator and brake pad components and rear view of the brake pad components, respectively.

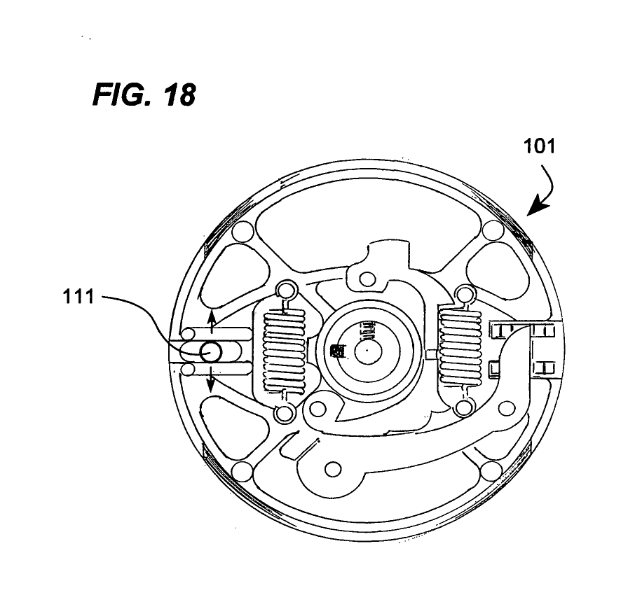

FIG. 18 Front view of the brake pad components.

### DETAILED DESCRIPTION OF THE PREFERRED EMBODIMENT

An ATV (10) has a power steering system (12) that complements a standard rack and pinion steering system (14) and is comprised of an actuator (16), a motor assembly (18), and cables (20, 20′) joining the motor assembly (18) to the rack and pinion steering system (14). The rack and pinion steering system (14) is pivotally connected to rods (22) which are themselves pivotally connected to a track connecting assembly (24). The track connecting assembly (24)—which is comprised of a curved element (25) a plate (23), and a plate holder (27)—acts as an interface between the tracks (26) and the the rack and pinion steering system (14). Other than that the manner by which the tracks (26) are built or are connected to the suspension system (21) of the ATV (10) is standard and will not be further discussed.

Steering is done in the conventional manner up until a sharp turn requires extra torquing as applied to the steering column (28) which rotates a connecting stem (30) which is rotationally attached to an extensible rod (32) which is part of a piston (34).

The piston (34) is made out of the extensible rod (32) and a body (36). Within that body (36) are two springs (38, 38′) and two plates (40, 40′) and the continuation of the extensible rod around which the plates (40, 40′) are fixedly attached. At rest, the piston (34) has the configuration of FIG. 5a, that is both springs (38, 38′) are un biased by the plates (40, 40′). When a hard turn on the steering column (28) has the connecting stem (30) pull on the extensible rod (32) as per FIG. 5b, spring (38) is compressed by plates (40) and contact (42) actuates switch (44). When a hard turn on the steering column (28) in the opposite direction has the connecting stem (30) push on the extensible rod (32) as per FIG. 5c, spring (38′) is compressed by plates (40′) and contact 42 actuates switch (44′). Depending upon which of the switches (44, 44′) are triggered, this will start the motor assembly (18) in one of two possible rotational direction. A small rotation of an electric motor (19) which is part of the motor assembly (18) is all that is needed to pull one of the cables (20, 20′) which then pulls on the rack and pinion steering system (14). It is obvious that electrical wiring is required between the swithes (44, 44′) and the electric motor and that a power supply such as a battery is required to power the electric motor (19) and as such, such obvious details will not be discussed further. The motor assembly (18) is held on a frame (17) installed on top of the hood (11) of the ATV (10) and is usually covered with a cover (15), it uses a system of magnetically actuated clutch (46) to actuate the cables (20, 20′). The clutch (46) is made up of a shaft connected disc (48) which is directly connected to shaft (50) of the electric motor (19).

An electro magnet (52) situated within a free disc (54) pulls a magnetically actuated disc (56) towards the free disc (54), taking with it pins (58) which are fixedly attached to the magnetically actuated disc (56). Each pin (58) enters one of a plurality of holes (60) made into the free disc (54) so as to lock the free disc (54) into rotation along with the shaft connected disc (48). When the electromagnet (52) is deactivated, biasing means (62) pull the magnetically actuated disc (56) towards the shaft connected disc (48) so that the free disc (54) is once again free.

This action of freeing and locking the free disc (54) is what causes the cables (20, 20′), which run around the periphery of the free disc in a cable slit (55), to be pulled or not. By being free, the free disc (54) is unencumbered when the tracks (26) reposition themselves straight after a turn so that the cables (20, 20′) can assume their neutral stance.

Each of the holes (60) is generally oval in shape so as to reduce the possibility of kickback when the pins (58) are entering. Also, larger holes (60) create more empty space through which the magnetic field can pass so that the magnetic pull is strong enough to be effective.

A variation in the motor assembly (18) has a series of the slip discs (64) replace the pin (58) and holes (60) system descibed hereinabove which leaves the rest of the operating system somewhat identical except that slip discs (64) help in regulating rotation of the free disc (54′), instead of the pin (58) and holes (60), so as to pull on the cables (20, 20′). The use of slip discs (64) is more suited to applications wherein not as much force is required for steering such as on snowmobiles which are easier to steer than ATVs (10) with tracks (26). The free disc (54′) is not required to have the holes (60) of the free disc (54) of the first embodiment. Also, a filler bushing (53) fills in the room otherwise occupied by part of the shaft connected disc (48) of the first embodiment which is not used in this embodiment but rather a slip disc cover (82) and a retainer plate (80) which extends from the shaft (50), both of which cooperating to retain all the slip discs (64). There are slip disc mechanical fasteners (84) to hold slip disc cover (82) and a retainer plate mechanical fastener (86) to hold the retainer plate (80). The key element here is the retainer plate (80) which normally holds the slip discs (64) quite loosely, so loosely that they slip and present very little friction, actuating the electro magnet (52) presses the retainer plate against the slip discs (64), thus increasing friction which has for effect of getting the free disc (54′) to rotate and pull on the cables (20) as per the previously descibed embodiment.

In yet another variation, of the motor assembly (18), an assembly similar to drum brakes replaces the slip discs (64) or the pin (58) and holes (60) described hereinabove. In this variation, the operating system is identical except that brake pads (100) are used to selectively engage or disengage a brake cylinder (102). When engaged on the brake cylinder (102), the electric motor (19) will induce rotation of the brake cylinder (102) around which are the cables (20) which are guided by the cable slit (55) which results in the desired steering action as described in the other embodiments. Additional components required for this variation are a brake cylinder support (104) which has a spacer bushing (106) extending therefrom and which is journaled onto the shaft (50) of the electric motor (19). The brake cylinder support (104) is mechanically attached to the frame (17) so as not to move and the wide part (107) of the spacer bushing (106) is journaled into a brake cylinder ball bearing (108). The brake cylinder ball bearing (108), is used to allow rotation of the brake cylinder (102). It is a given that brake pads (100), and associated brake pad components (101) (a series of parts known in the art and referred herein as brake pad components (101)), are the means that interface with the brake cylinder (102) in a fashion quite similar to how they are used in the automotive industry. The difference is in how the brake pads (100) are actuated. In the automotive industry, a hydraulic piston would normally push the brake pads (100) so that they make contact with the brake cylinder (102). But in this embodiment, an actuator (110) and a clutch plate (112) are moved by the electro magnet (52). Normally, the actuator (110) is pressed against the brake pads (100) but when loosened by tha action of the electro magnet (52), the actuator (110) no longer rotates along with the brake pads (100), which rotate due to the rotation of the motor (19). Not rotating along, makes the actuator (110) move like a pendulum (see arrows) one direction or the other depending upon the rotating direction of the motor (19) which is itself governed by whether the steering action is to the left or to the right. The pendulum motion is limited by a wide slot (122) carved into the clutch plate (112). The rotational axis of the actuator (110) is located at an axis bearing (114), with the axis bearing (114) moving within a bearing cavity (115) also located on the clutch plate (112), as well as a shaft passage hole (51) for the shaft (50) is also located on the. On the actuator (110) is a large oval opening (124) This opening allows passage of the shaft (50) and is oval because of the pendulum motion of the actuator (110), the pendulum movement also moves the actuator (110) in such a way that the bearing cavity (115) needs to be oval rather than round to accomodate the axis bearing (114). By moving like a pendulum in one direction or the other according to steering needs, a cam (111) pushes on either one of the the brake pads (100). When the electro magnet (52) is deactivated, a clutch plate spring (113) pushes the clutch plate (112) and the actuator (110) towards the brake pads (100) which is the rest position until a new steering change reactivates the electro magnet (52) and the motor (19). A cover (120) seals the components situated between it and the brake cylinder support (104) which also acts as a seal to the brake cylinder (102).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A power steering system that complements a standard rack and pinion system comprising:
an actuator, a motor assembly, and cables;
said cables joining said motor assembly to said rack and pinion steering system;
said rack and pinion steering system being pivotally connected to rods;
said rods being themselves pivotally connected to a track connecting assembly;
said track connecting assembly acting as an interface connecting said tracks and said rack and pinion steering system;
a torque applied to a steering column rotates a connecting stem;
said connecting stem being rotationally attached to an extensible rod;
said extensible rod being part of a piston;
said piston consisting of said extensible rod and a body;
two springs and two plates are located within said body as well as part of said extensible rod which extends into said body;
said plates being fixedly attached to said extensible rod;
a motor, part of a motor assembly, to effect pulling of said cables by way of its rotation;
said motor assembly being fixedly attached on a frame located at a suitable place on a vehicle;
said motor assembly further comprising an electro magnetically actuated clutch means to actuate said cables.

2. A power steering system as in claim 1 wherein:
said rack connecting assembly being further comprised of a curved element, a plate, and a plate holder.

3. A power steering system as in claim 1 wherein:
said clutch means comprising of a shaft connected disc;
said shaft connected disc being directly connected to a shaft of said motor;
an electro magnet located within a free disc pulls a magnetically actuated disc towards said free disc, taking with it a plurality of pins which are fixedly attached to said magnetically actuated disc;
each one of said plurality of pins entering one of a plurality of holes made into said free disc so as to lock said free disc into rotation along with said shaft connected disc;
when said electro magnet is deactivated, biasing means pull said magnetically actuated disc towards said shaft connected disc so that said free disc is once again free;
locking said free disc into rotation induces rotation of said free disc which induces pulling of said cables rlocated peripherically off said free disc in a cable slit.

4. A power steering system as in claim 3 wherein:
each of said holes of said free disc being oval in shape so as to reduce kickback when said plurality of pins enter said plurality of holes.

5. A power steering system as in claim 1 having a method of operation comprising the steps of:
at rest, said piston has both springs un biased by said plates;
when a turn on the steering column has said connecting stem pull on said extensible rod, said one of springs is compressed by said one of plates and said contact actuates one of said switches;
a turn on said steering column in an opposite direction has said connecting stem push on said extensible rod and other of said springs is compressed by other one of said plates and said contact actuates other one of said switches.

6. A power steering system as in claim 1 wherein:
said clutch means comprising a shaft connected disc;
said shaft connected disc being directly connected to said shaft of said motor;
said electro magnet located within said free disc pulls a magnetically actuated disc towards said free disc;
a series of slip discs regulate rotation of said free disc so as to pull on said cables;
a retainer plate extending from said shaft and a slip disc cover, both cooperating to retain said slip discs;
slip disc mechanical fasteners to hold said slip disc cover;
a retainer plate mechanical fastener to hold said retainer plate;
said electro magnet moving so as to press said retainer plate against said slip discs so as to increase friction between said slip discs so that said free disc rotates and pulls on said cables.

7. A power steering system as in claim 1 wherein:
said clutch means consisiting of brake pads selectively engaging or disengaging a brake cylinder;
said motor inducing rotation of said brake cylinder when said brake pads engage said brake cylinder;
said brake cylinder rotating so that said cables guided by said cable slit are pulled so as to provide steering;
brake pad components comprising said brake pads being actuated by said electro magnet moving an actuator and a clutch plate;
a wide slot carved into said clutch plate;
rotational axis of said actuator located at an axis bearing;
said axis bearing moving within a bearing cavity located on said clutch plate;
a shaft passage hole for passing said shaft located on said clutch plate;
an oval opening located on said actuator to allow passage of said shaft.

8. A power steering system as in claim 7 having a method of operation comprising the steps of:
said electro magnet moving said actuatior away from said brake pads so that said actuator no longer rotates along with said brake pads;
said actuator then moves in one of two possible direction in relation with said brake pads which both results in said actuator applying biasing pressure against either one of said brake pads;
said brake pads causing said brake cylinder rotating so that said cables guided by said cable slit are pulled so as to provide steering.
